(19) United States
(12) Patent Application Publication
(10) Pub. No.: US 2017/0170874 A1
(43) Pub. Date: Jun. 15, 2017

(54) HUMAN MACHINE INTERFACE FOR ELECTRONIC CONTROL DEVICES

(71) Applicant: BGM Engineering, Inc., Shelby Township, MI (US)

(72) Inventors: William Thomas Burgett, Lake Orion, MI (US); Joseph Francis Mazur, Leonard, MI (US)

(73) Assignee: BGM Engineering, Inc., Shelby Township, MI (US)

(21) Appl. No.: 15/376,047

(22) Filed: Dec. 12, 2016

Related U.S. Application Data
(60) Provisional application No. 62/386,721, filed on Dec. 11, 2015.

(51) Int. Cl. H04B 5/00; H04M 1/725; H04W 4/00

(52) U.S. Cl. CPC H04B 5/0025; H04W 4/008; H04B 5/0081; H04M 1/72583

(57) ABSTRACT

A process for interfacing with an electronic device, such as to adjust control settings using a portable device, includes providing a short range wireless communication enabled device, and a portable short range wireless communication enabled device having a touch-screen display. An application is executed on the portable device to present a graphical user interface on the display. The graphical user interface includes icons or words corresponding with control of operational features of the electronic device. Commands entered through the graphical user interface are communicated to the electronic device via short range wireless communication (e.g., NFC), such as to adjust control settings on the electronic device.

### CROSS-REFERENCE TO RELATED APPLICATIONS

This application claims priority to provisional Application No. 62/386,721 filed on Dec. 11, 2015, which is incorporated herein by reference in its entirety.

### FIELD OF THE DISCLOSURE

This disclosure pertains to human-machine interfaces, electrical and electronic devices provided with wireless communications capability to enable human-machine interfacing via a portable device, and methods of controlling electronic devices having embedded wireless communications capability.

### BACKGROUND OF THE DISCLOSURE

Many electronic control devices rely on user programmability in order to fully realize the product's full potential. This user programmability is accomplished through a Human Machine Interface (HMI), which many times includes a display, a keyboard, a keypad or similar switch panel. The settings on these devices are sometimes never or rarely changed during the life of the product. The cost to develop and manufacture the HMI adds very significantly to the final cost of the product. Many times, the HMI is highly vulnerable to failure that renders the product unusable.

With some products today, user programmability can be done remotely with the use of smart phones and other connected devices becoming more and more prevalent (in 2015 the Pew Research Center estimated that roughly 64% of American adults own a smart phone). Typically this kind of communication is done via Bluetooth or Wi-Fi. Examples include “smart home” devices such as thermostats or garage door openers that are Wi-Fi-enabled. The downside to these types of devices is that they require an interne connection to operate, and they also provide a potential security risk.

### SUMMARY OF THE DISCLOSURE

A method for communicating with products using short range wireless communication, such as Near Field Communication (NFC), is disclosed. By utilizing this technology to communicate with various products, a smart phone or tablet could effectively replace the HMI portion of those products, making them more robust and cheaper to produce. This interface can be used to operate a device, and also provide the user with important information on the product such as instructions or diagnostics.

The process involves providing a short range wireless communication enabled electronic device, such as a NFC-enabled device, having a controller for selectively controlling operational features of the electronic device and a portable short range wireless communication enabled (e.g., NFC-enabled) device having a touch-screen display. An application is executed on the portable device to present a graphical user interface (GUI) on the touch-screen display that emulates at least some of the features of either an actual HMI interface or an HMI interface that would normally be used on the electronic device. The application allows entry of commands (e.g., control settings for the electronic device) and communication of the commands from the portable device to the electronic device via short range wireless communication, such as NFC. The portable device can be positioned in proximity of the electronic device to facilitate short range wireless communication (such as NFC) between the portable device and the electronic device either while or after the commands are entered via the GUI on the portable device.

The appliances or other electronic devices that are used in the process include a controller for selectively operating functional features of the electronic device, a short range wireless communication (such as NFC) interface, and a target indicator for providing a visual cue for establishing proximity of a portable short range wireless communication enabled device to facilitate short range wireless communication between the electronic device and the portable device.

### BRIEF DESCRIPTION OF THE DRAWINGS

FIG. 1 is a schematic illustration of a process for connecting a portable device with NFC capability with an electronically controlled device with NFC capability to facilitate programming of the electronically controlled device using a human-machine interface displayed on the portable device.

FIG. 2 is a schematic illustration of a modified process of FIG. 1.

FIGS. 3A and 3B are perspective views of a system or set of components that can be used to practice the process illustrated in FIGS. 1 and 2.

FIGS. 4A and 4B are perspective views of a particular application of the disclosed process and system used for programming a coffee brewing machine.

FIGS. 5A and 5B are perspective views of a particular application of the disclosed process and system used for programming a dishwashing machine.

FIGS. 6A and 6B are perspective views of a particular application of the disclosed process and system used for programming a vending machine.

### DETAILED DESCRIPTION OF THE ILLUSTRATED EMBODIMENTS

Near field communication, abbreviated NFC, is a form of contactless communication between devices like smartphones or tablet computers. Contactless communication allows a user to wave the smartphone over a NFC compatible device to send information without needing to touch the devices together or go through multiple steps setting up a connection. Fast and convenient, NFC technology is popular in parts of Europe and Asia, and is quickly spreading throughout the United States.

While the devices and methods disclosed herein are described primarily with reference to the use of NFC, other forms of short range wireless communication that are limited to a few centimeters (e.g., 1 to 10 cm) are envisioned, especially other forms of communication employing electromagnetic induction between loop antennas.

This technology can be used to easily pair with devices as all it needs is a simple tap over the other NFC enabled device. This would result in pairing with the device it has been tapped on. A smartphone could be used for remotely operating home appliances. Only a tap on the appliance would be needed to connect with that appliance and then the appliance could be remotely controlled by Bluetooth technology.

As the name Near Field Communication implies, it's a wireless technology that only works over a very “near”/short distance, usually a centimeter or two. Typically this involves touching (“tapping”) your device to the tag or chip (since you have to allow for the bulk of the tag container and phone body). NFC operates at 13.56 MHz and at data rates ranging up to 424 kbps.

Just as with other proximity card technologies, NFC works using magnetic induction between two loop antennas located within each other's “near field,” effectively forming an “air-core transformer.” In other words, power can be transferred (“induced”) in an otherwise passive, unpowered chip (usually referred to as the “target”), after which basic RF data transfer can occur. So NFC targets can be simple tags, stickers or cards that do not require batteries and can be extremely small and thin.

The target can be passive (not powered) or powered for so-called “peer-to-peer” communication. For example, two smartphones, or a smartphone and a headset or other accessory can be engaged in peer-to-peer NFC. In this “active” mode, both the initiator and the target device communicate by alternately generating their own “near” radio frequency modulations. They take turns sending information—each device deactivates its RF field while it is waiting for data so that it can pick up modulations from its NFC partner.

The disclosed electronic devices can include the following items to facilitate programming of the electronic device using a NFC-enabled portable device:

(1) NFC hardware and software on the product;

(2) A target indicator on the product, and

(3) A discovery application on the connected device.

In the disclosed process, a product with the NFC hardware and software is provided. The user installs a discovery application on their portable device, and can enter a unique device identification code (ID).

When the user wants to control their device, they can put the connected device in a location that is identified by the target indicator. NFC communication can begin with a handshaking sequence that can verify the ID of the product and begin communication with the product. The product can serve up an application to the device, which displays a user interface (GUI) that can look very similar to the HMI interface that is or would normally be part of the device. Alternatively, the GUI can be downloaded onto the portable device using a different method, such as from the internet via Wi-Fi or other wireless process (e.g. 4G).

The user can then activate virtual switches, dials and controls and view the settings on the display. All other functions that can be done on the HMI can be done via this interface. This includes setting times for events to occur, settings temperatures for operations to occur at, etc. In the case of commercial applications, such as a vending machine or fast food kiosk, this interface and secure connection could be used to view a menu, order and even pay.

Once the user has finished interacting with the product, the connected device can be tapped against the target indicator and removed to communicate the entered settings and close the communication session. Alternatively, the portable device can be left on the product (electronic device) while the user enters the preferred settings and removed after setting entries have been completed to communicate the entered settings to the product and close the communication session.

The term “electronic device” as used in this disclosure and the claims encompasses any home appliance, such as dishwashing machines, refrigerators, clothes washing machines, clothes drying machines, coffee brewers, etc; vending machines; thermostats; and other electrically powered devices having electronic circuitry for storing and/or regulating control settings for the electronic device.

The term “controller” refers to electronic circuitry for operating functional features of the electronic device in accordance with user selected settings.

The “functional features” that can be controlled include, for example, brew time, brew strength, and brew start time for a coffee brewing machine; water temperature, agitation strength, agitation time, number of rinse/spin cycles, etc. for a clothes washing machine; wash, rinse, dry and sanitize settings for a dishwashing machine; and temperature/time settings for a thermostat. More generally, such functional features include any user controllable aspect of an electronic device, such as motor speeds, compressor speeds, temperatures, humidity, timers, etc.

The term “near field communication interface,” as used herein, refers to either an active or passive NFC device, depending on whether the electronic device communicates information to the portable device on which the GUI for the electronic device is displayed. For example, if the GUI is downloaded from the interne rather than from the electronic device that is being programmed (i.e., set), a passive NFC device or interface can be employed on or in the electronic device. While such passive NFC interfaces can be single write devices, rewritable devices are highly preferred for most applications.

The “target indicator” 3 can be any indicia or product configuration (e.g., surface contours of a product housing) that provides a visual cue that guides the user into appropriately positioning the portable NFC-enabled device to allow NFC between the portable device and the electronic device (i.e., from the portable device to the electronic device, or two-way communication between the devices).

The term “portable device” refers to any device that can be powered by a battery or batteries and has a touch-screen display. Typically, the portable device is a smart phone or a tablet computer.

The terms “near field communication enabled device” and “NFC-enabled device” refer to an electronic device or portable device having a near field communication interface. In the case of the portable device, the near field communication interface will usually be an active NFC interface.

A touch-screen display is a display screen that also acts as an input device. The screen is sensitive to touch by a user (usually pressure-sensitive) and allows the user to interact with the computing functionality of the device by touching pictures (icons) or words on the screen.

In certain contexts, the term “application” refers to a computer program that can be executed on a portable device.

The term “graphical user interface” is a graphical display that acts as a user interface and allows a user to interact with an electronic device through graphical icons, words or other visual indicators.

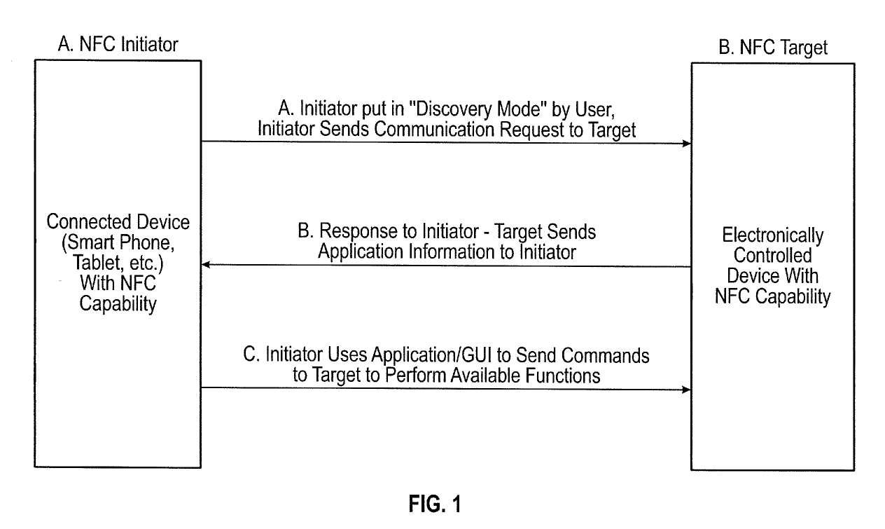

A process for interfacing with an electronic device using a portable device and NFC is schematically illustrated in FIG. 1. The portable device or connected device (e.g., smart phone, tablet computer or the like, with NFC capability) acts as an NFC initiator that sends a communication request to an electronic device with NFC capability (the NFC target). The target can then send application information to the initiator (e.g., a GUI for the electronic device). Alternatively, the GUI can be downloaded to the portable device using other methods, such as from the internet. For example, the GUI application can be obtained via Bluetooth, Wi-Fi or other communication means from visiting a website associated with the electronic device. The URL for the website can be provided with the operating instructions for the electronic device or can be obtained from the NFC target. Once the appropriate GUI has been displayed, the user can enter desired control settings which can be sent to the NFC target either as the settings are entered (if the portable device is in sufficiently close proximity to the NFC target during interaction between the user and GUI) or after the user has finished entering all desired settings (by bringing the NFC initiator in sufficiently close proximity to the NFC target to facilitate NFC).

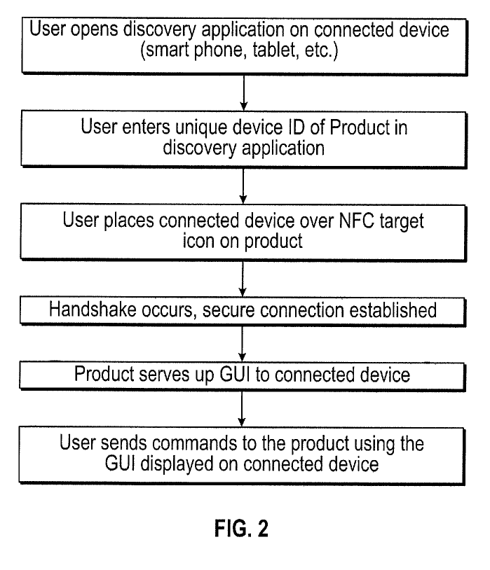

FIG. 2 schematically illustrates a process in accordance with FIG. 1. This process includes user entry of a unique device ID to the product (electronic device). This provides a layer of protection against unauthorized modification of the electronic device settings. The ID, for example, can be printed or embossed on a discreet location on the electronic device or provided on the user manual. It is also possible to email the ID to the user, such as during product registration.

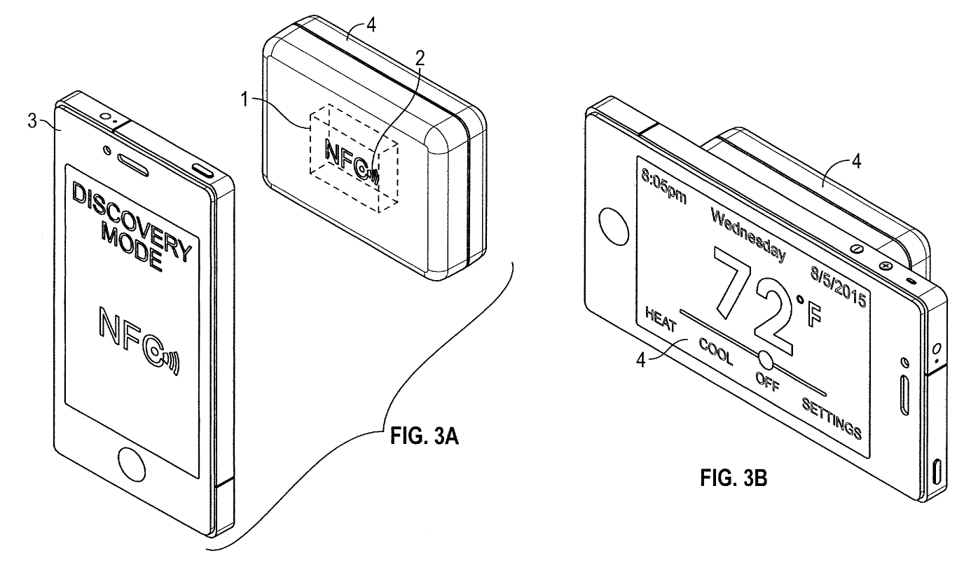

FIG. 3A shows the basic components of a system for practicing a process in accordance with this disclosure. The system includes a NFC target 1 that can be incorporated into an electronic device (product), a target indicator 2 (a graphical image on the surface of the electronic device housing), and a portable device 3 (e.g., cell phone) having NFC capability (NFC-enabled). FIG. 3 shows the NFC target 1 and portable device 3 in sufficiently close proximity (e.g., within a few centimeters) to the target 1 to facilitate NFC between the devices. In this example, the electronic device 4 is a thermostat.

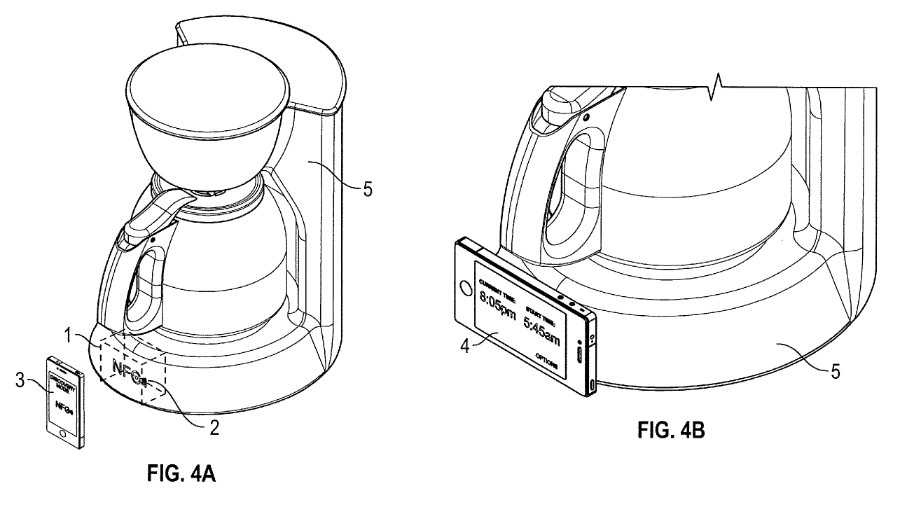

FIGS. 4A and 4B show another application in which the system is used for adjusting the brew settings on a coffee brewing machine 5.

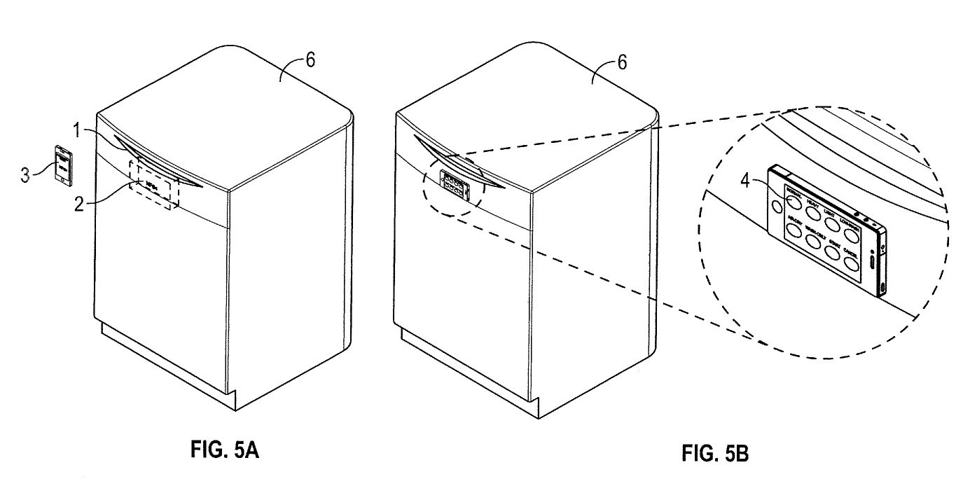

FIGS. 5A and 5B show another application in which the system is used for adjusting settings on a dishwashing machine 6.

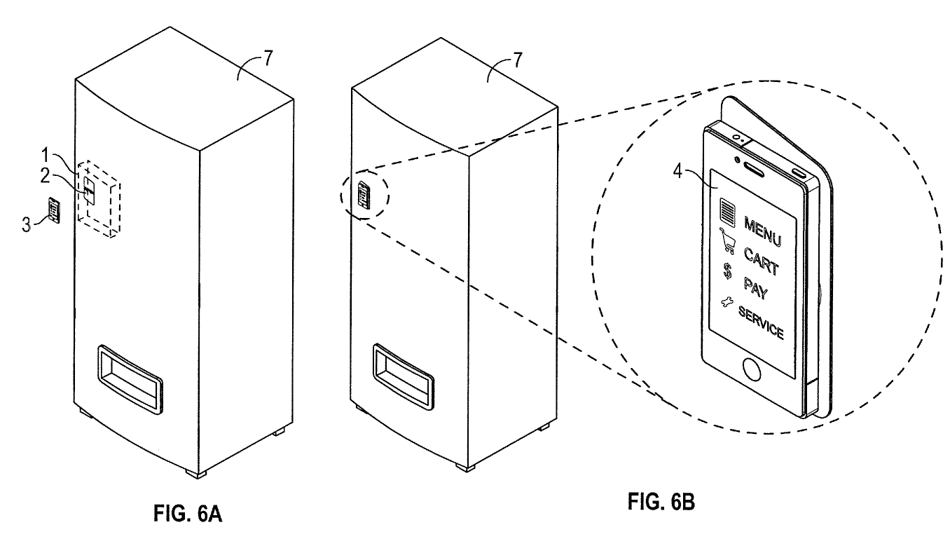

FIGS. 6A and 6B show another application in which the system is used for controlling operation of a vending machine 7. In this application, the NFC target in the vending machine 7 can communicate a listing of items available from the vending machine and prices associated with the items. The user can select desired items from the vendor and choose a method of payment. Appropriate account information is communicated to the vendor and the selected items are dispensed.

The systems and processes disclosed and claimed herein have certain advantages over known processes using Bluetooth, Wi-Fi or other similar communication techniques for controlling settings on products or operating vending machines. By relying entirely on NFC, security is greatly improved. Communication of sensitive information cannot be intercepted because of the very short range of NFC (a few centimeters), and modification of settings cannot be done remotely in a discreet manner, but must instead be done in an overt manner that can be easily detected. The systems and processes disclosed herein can allow manufacturers to significantly reduce costs by eliminating HMI's or providing less expensive, reduced functionality HMI's on certain products. Additionally, the systems and processes disclosed herein allow expanded functionality that is not practical with conventional HMI's. For example, the virtual HMI displayed in a GUI on a touch-screen display of a portable device can offer additional control setting options (e.g., continuously variable setting rather than discrete settings), diagnostics and/or operating instructions.

Although use of Wi-Fi, Bluetooth or wireless communication other than NFC could compromise certain advantages of the process, the application residing on the portable device could be written to optionally allow such communications if desired.

While the present invention is described herein with reference to illustrated embodiments, it should be understood that the invention is not limited hereto. Those having ordinary skill in the art and access to the teachings herein will recognize additional modifications and embodiments within the scope thereof Therefore, the present invention is limited only by the claims attached herein.

What is claimed is:

1. A process for interfacing with an electronic device, comprising:
providing a short range wireless communication enabled electronic device having a controller for selectively controlling operational features of the electronic device;
providing a portable short range wireless communication enabled device having a touch-screen display;
executing an application on the portable device for presenting a graphical user interface on the touch-screen display that includes graphical icons or words corresponding with control of operational features of the electronic device, and communicating commands entered through the user interface displayed on the touch-screen display to the controller using short range wireless communication; and
positioning the portable device in proximity of the electronic device to facilitate short range wireless communication between the portable device and the electronic device.

2. The process of claim 1, wherein the short range wireless communication is achieved using electromagnetic induction between loop antennas.

3. The process of claim 1, wherein the short range wireless communication is Near Field Communication.

4. An electronic device comprising:
a controller for selectively operating functional features of the electronic device;
a short range wireless communication interface; and
a target indicator for providing a visual cue for establishing proximity of a portable short range wireless communication enabled device to facilitate short range wireless communication between the electronic device and the portable device.

5. The device of claim 4, wherein the short range wireless communication is achieved using electromagnetic induction between loop antennas.

6. The device of claim 5, wherein the short range wireless communication is Near Field Communication.
